(19) United States
(12) Patent Application Publication
(10) Pub. No.: US 2025/0092528 A1
(43) Pub. Date: Mar. 20, 2025

(54) TITANIUM ALLOY POWDER RECONDITIONING FOR 3D ADDITIVE MANUFACTURING

(71) Applicant: NUtech Ventures, Lincoln, NE (US)

(72) Inventors: Gordon Chou, Lincoln, NE (US); Li TAN, Lincoln, NE (US); Sean THOMPSEN, Lincoln, NE (US)

(21) Appl. No.: 18/968,470

(22) Filed: Dec. 4, 2024

Related U.S. Application Data
(63) Continuation of application No. PCT/US2023/068796, filed on Jun. 21, 2023.
(60) Provisional application No. 63/353,885, filed on Jun. 21, 2022.

(51) Int. Cl. C23F 1/00; B33Y 40/10

(52) U.S. Cl. CPC C23F 1/00; B33Y 40/10

(57) ABSTRACT

Aspects disclosed herein include a method for deoxidization of a metal material comprising one or more metal oxide materials, the method comprising: reducing a concentration of the one or more metal oxide materials in the metal material from an initial concentration to a final concentration, thereby forming a deoxidized metal material; wherein the step of reducing comprises: etching the metal material using a reactive gas to expose one or more metal oxide materials; and separating the exposed one or more metal oxide materials from the etched metal material; wherein the step of separating comprises: processing the etched metal material in a solvent and extracting the exposed one or more metal oxide materials.

### CROSS-REFERENCE TO RELATED APPLICATIONS

This patent application is a continuation application of International Application No PCT/US2023/068796, filed Jun. 21, 2023, which claims the benefit of U.S. Provisional Patent Application No. 63/353,885, filed Jun. 21, 2022, which are both incorporated by reference in their entireties for all purposes.

### STATEMENT REGARDING FEDERALLY SPONSORED RESEARCH OR DEVELOPMENT

This invention was made with government support under Award Number 2121590 awarded by the National Science Foundation. The government has certain rights in the invention.

### BACKGROUND

The titanium alloy material Ti-6Al-4V (also referred to as “Ti64”) is useful for additive manufacturing. For example, Ti-6Al-4V is used in processes such as laser powder bed fusion (L-PBF) additive manufacturing. During repeated additive manufacturing, Ti-6Al-4V forms oxides such as titania, which causes the flexibility and toughness of the printed parts to decrease, especially after repetitive use. L-PBF processing, for example, includes heating the Ti64 powder to 500-600° C., resulting in formation of an oxide layer on particles. The Ti-6Al-4V alloy is expensive, however, to replace. Accordingly, there is need in the art for reconditioning or deoxidizing oxidized Ti-6Al-4V so that the alloy may be reused, after oxides are removed.

### SUMMARY

Provided herein are methods for deoxidization, also referred to herein as reconditioning, oxidized titanium alloy materials by removing oxides and making the reconditioned titanium alloy material useful for additive manufacturing.

Aspects disclosed herein include a method for deoxidization of a metal material comprising one or more metal oxide materials, the method comprising: reducing a concentration of the one or more metal oxide materials in the metal material from an initial concentration to a final concentration, thereby forming a deoxidized metal material; wherein the step of reducing comprises: etching the metal material using a reactive gas to expose one or more metal oxide materials; and separating the exposed one or more metal oxide materials from the etched metal material; wherein the step of separating comprises: processing the etched metal material in a solvent and extracting the exposed one or more metal oxide materials.

Aspects disclosed herein include a method for deoxidization of a titanium alloy material, the method comprising: reducing a concentration of one or more metal oxide materials in the titanium alloy material from an initial concentration to a final concentration; wherein the step of reducing comprises: etching the titanium alloy material using a reactive gas to expose one or more metal oxide materials; and separating the exposed one or more metal oxide materials from the titanium alloy material.

Aspects disclosed herein include a method for deoxidization of a titanium alloy material, the method comprising: reducing a concentration of one or more metal oxide materials in the titanium alloy material from an initial concentration to a final concentration; wherein the step of reducing comprises: etching the titanium alloy material using a reactive gas to expose one or more metal oxide materials; and separating the exposed one or more metal oxide materials from the titanium alloy material using a solvent extraction.

Aspects disclosed herein include a method for deoxidization of a titanium alloy material, the method comprising: reducing a concentration of one or more metal oxide materials in the titanium alloy material from an initial concentration to a final concentration; wherein the step of reducing comprises: etching the titanium alloy material using a reactive gas to expose one or more metal oxide materials; milling the etched titanium alloy material; and separating the exposed one or more metal oxide materials from the titanium alloy material.

According to an aspect, the metal material is a metal alloy material. According to an aspect, the metal alloy material is a titanium alloy material. According to an aspect, the titanium alloy material comprises a Ti-6A1-4V alloy. According to an aspect, the metal material is in the form of a powder.

According to an aspect, the gas and/or metal material is at a temperature greater than 50° C. According to an aspect, the gas and/or metal material is at a temperature greater than 200° C. According to an aspect, the reactive gas comprises chlorine gas.

According to an aspect, the step of etching comprises etching a metallic composition of the metal material. According to an aspect, the reactive gas etches titanium from the metal material resulting in exposing titania at surfaces of the metal material; wherein the metal material is a titanium alloy material. According to an aspect, the reactive gas reacts with and etches away Ti and/or V from the metal material; wherein the metal material is a titanium alloy material.

According to an aspect, the reaction temperature varies with oxygen content, with up to about a 5° C. increase per 10 ppm increase in the oxygen concentration.

According to an aspect, the step of etching comprises a reaction according to formula FX1: Ti+2Cl₂→TiCl₄ (FX1).

According to an aspect, a method further include milling the etched metal material after the step of etching and prior to the step of separating. According to an aspect, the milling step comprises ball milling.

According to an aspect, the one or more metal oxide materials comprise titania.

According to an aspect, the final concentration of the one or more metal oxide material is sufficiently low for the deoxidized metal material to be useful for additive manufacturing. According to an aspect, the final concentration of the one or more metal oxide material in the deoxidized metal material is undetectable by EDAX.

According to an aspect, the initial concentration of the one or more metal oxide material in the metal material is at least 2.5 at. % according to an EDAX technique. According to an aspect, the initial concentration of the one or more metal oxide material in the metal material is selected from the range of 3 at. % to 5 at. % according to an EDAX technique.

According to an aspect, the solvent comprises an organic solvent.

According to an aspect, the step of processing comprises sonicating the etched titanium alloy material in the solvent.

According to an aspect, the step of separating comprises centrifuging and extracting the solvent having the exposed one or more metal oxide materials dispersed in the solvent.

According to an aspect, the methods herein are applicable to titanium alloys of different history, different shelving life and/or different amounts of oxygen content. According to an aspect, the methods herein are applicable to titanium alloy powders of different amounts of oxygen content. According to an aspect, a number of different powders in the mixture is equivalent to the number of different reaction temperatures. According to an aspect, the composition or ratio of the mixed powders may be evaluated using the peak area integrated from the spectroscopy of the reaction product.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1: Scanning electron microscope (SEM) image of a titanium alloy material with a layer of metal oxide material. Bulk Ti64 alloy forms a thick oxide layer at 400° C. (air). Oxidation is easier for Ti64 powders, such as at 300° C. (e.g., 20 min in air).

FIGS. 2A-2B: A schematic showing an oxide layer on a particle (2A) and a plot of oxygen concentration vs. powder particle diameter and showing corresponding Grade classification. A thin oxide lowers the Grade of the material.

FIGS. 3A-3B: X-ray photoelectron spectroscopy (XPS) plots showing formation of metal oxide layer(s) by thermal treatment of metal or alloy powder. For example, a 30 nm metal oxide layer is formed in order to perform deoxidization analysis on the oxidized material.

FIG. 4: A schematic showing exemplary embodiments of methods disclosed herein including gas phase etching and solvent extraction. Surface oxides (TiO₂ and Al₂O₃) are generally inert. Converting TiO₂ to Ti requires high temperatures (e.g., >450° C.) and the use of catalyst (e.g., carbon nanotubes). Instead, as shown in the schematic here, gas phase etching and solvent extraction can instead be used to expose and remove thin layers of oxides.

FIGS. 5A-5C: A plot of temperature vs. time in a furnace for thermally oxidizing titanium alloy powder, for example.

FIGS. 6A-6B: Schematics of portions of exemplary experimental setups for gas phase etching, according to certain embodiments herein. Object 1 is an Argon tank; Object 2 is an adapter; Object 3 is a chlorine tank; Object 4 is a regulator; Object 6 is a rotameter; Object 7 is an adapter; Object 8 is an adapter; Object 9 is regulator. “Gas out” refers to the system being optionally located at an inlet side of a processing tube. “Gas out” refers to the system being optionally located at an outlet side of a processing tube.

FIGS. 7A-7C: Photographs of portions of exemplary experimental setups for gas phase etching, according to certain embodiments herein.

FIGS. 8A-8B: SEM images of exemplary oxidized titanium alloy powder prior to deoxidization, according to embodiments herein.

FIGS. 9A-9B: photographs of a working example of reactive etching of the oxidized titanium alloy powders with reactive gas comprising Cl₂ gas. The smoke corresponds to formation of TiCl₄ from reaction of the Cl₂ and Ti in the titanium alloy powder,

FIGS. 10A-10B: SEMs of powder (Ti64) oxidized at 400° C. for 20 minutes and then subsequently etched in a sealed tube using Cl₂ as a reactive gas, according to various exemplary embodiments of methods herein.

FIGS. 11A-11B: SEMs of powder (Ti64) oxidized at 350° C. for 1 hour and then subsequently etched in a sealed tube using Cl₂ as a reactive gas, according to various exemplary embodiments of methods herein. In embodiments, exposed metal oxide patches/islands/portions may be generally rough and porous. In embodiments, the exposed metal oxide portions may be Ti-poor and O-rich as shown in FIG. 11B.

FIG. 12: table of material properties for TiO₂ and chloride materials that may be formed as a result of reactions between reactive Cl₂ gas and elements of the titanium alloy powder.

FIGS. 13A-13B: SEM images of extracted metal alloy powder, which corresponds to the reconditioned or deoxidized titanium alloy material, according to various exemplary embodiments of methods herein. The sample shown in these figures was first oxidized at 350° C. for 20 minutes, then etched in an open tube setup using Cl₂ gas, then sonicated in IPA and centrifuged.

FIGS. 14A-14C: Preliminary EDAX data. The oxygen content was undetectable by EDAX after a reconditioning (deoxidation) process according embodiments herein.

FIGS. 15A-15B: FIG. 15A shows a XPS plot corresponding to metal powder after deoxidization according to various embodiments disclosed herein, showing evidence of Ti, with optionally a thin native oxide layer. FIG. 15B shows a XPS plot corresponding to the extracted metal oxide (including TiO₂) material extracted from the metal alloy material, according to various embodiments disclosed herein.

FIGS. 16A-16B: FIG. 16A shows a XPS plot corresponding to metal powder after deoxidization according to various embodiments disclosed herein, showing evidence of Al. FIG. 16B shows a XPS plot corresponding to the extracted metal oxide (including Al₂O₃) material extracted from the metal alloy material, according to various embodiments disclosed herein.

FIG. 17: SEM images of extracted metal oxide materials, according to various exemplary embodiments of methods herein. The sample shown in these figures was first oxidized at 350° C. for 20 minutes, then etched in an open tube setup using Cl₂ gas, then sonicated in IPA and centrifuged.

FIG. 18: A schematic showing certain exemplary embodiments of a method for deoxidizing a titanium metal alloy material.

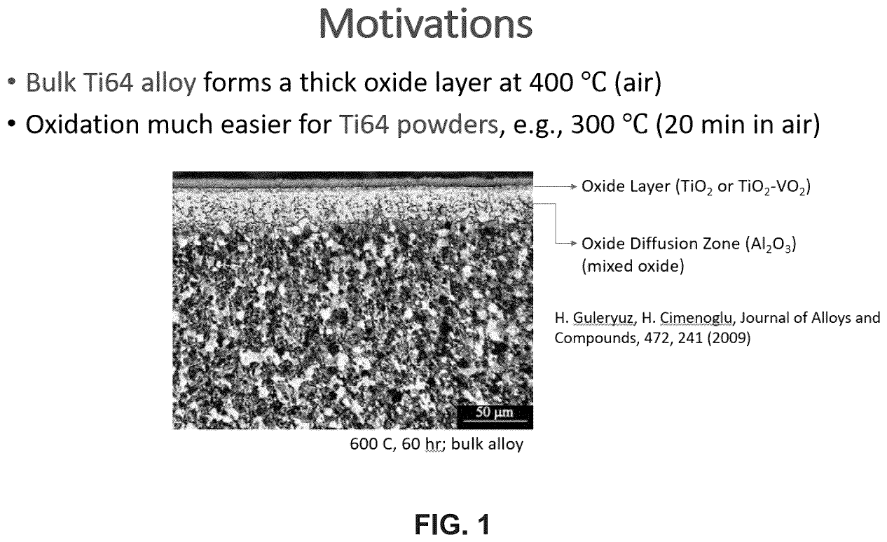

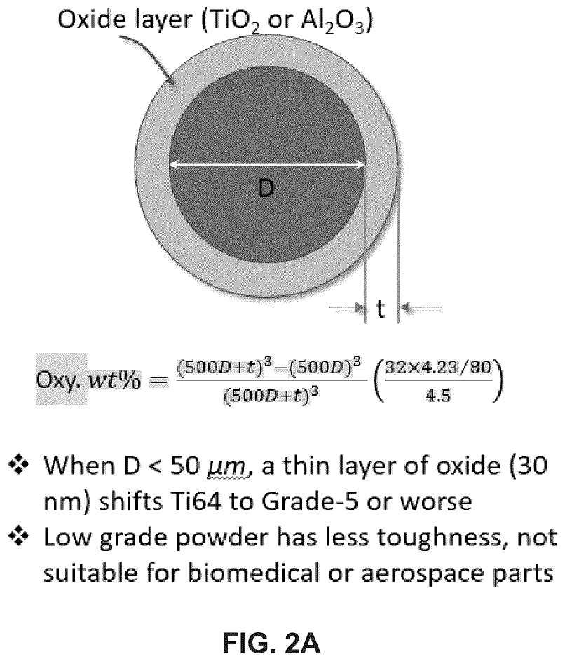

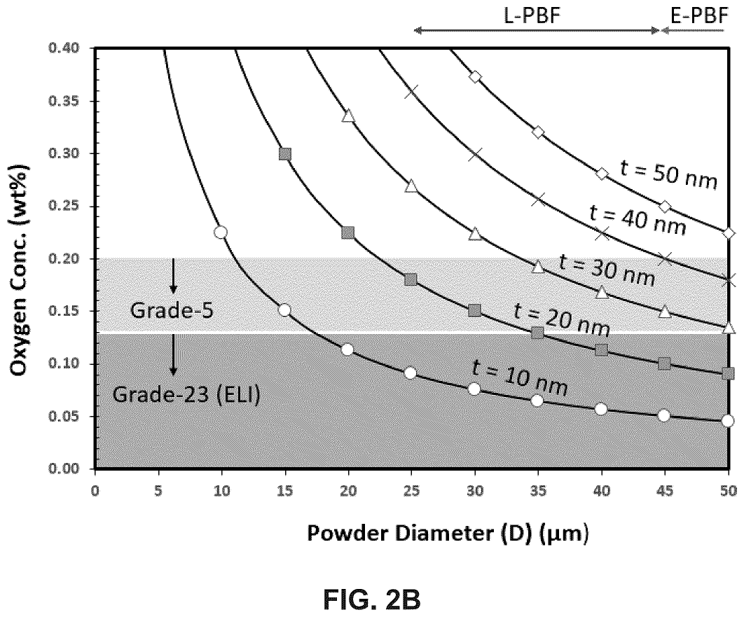

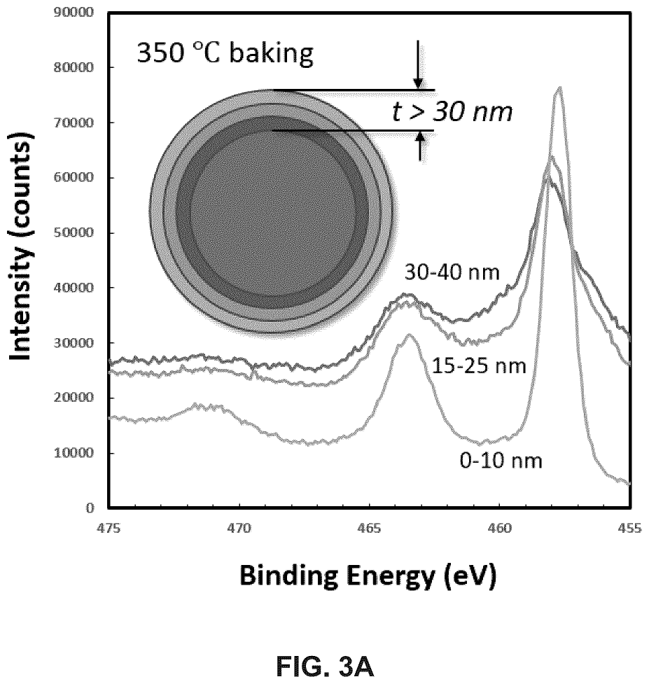

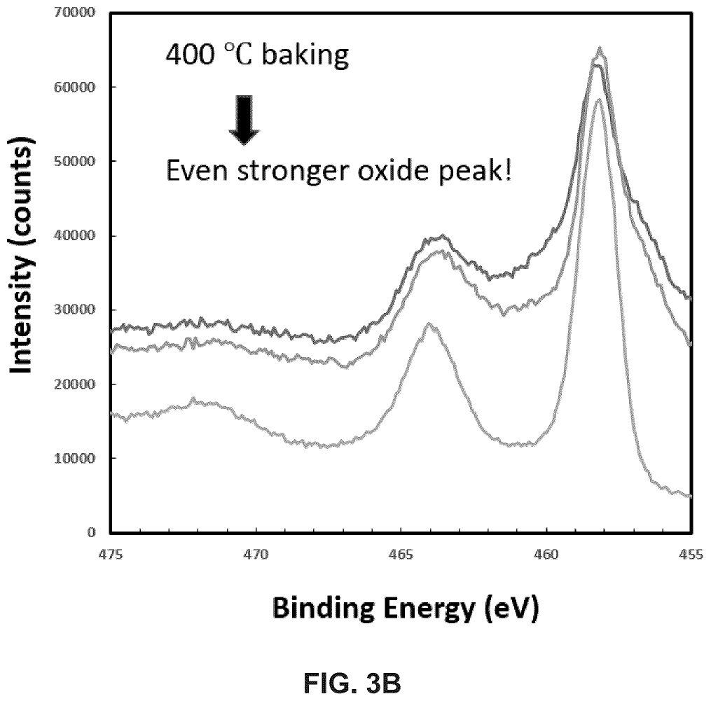

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

The term “deoxidizing” refers to removal of at least a fraction of one or more oxide or oxygen-containing materials, such as one or more metal oxide materials, such as, but not limited to, titania, alumina, and/or vanadium oxide.

As used here, atomic ratio(s) or atomic concentration(s) described as “near-equal” refers to a variation of up to 10%, optionally up to 5%, in the value of the atomic ratio(s) or atomic concentration(s) from the value corresponding to an equal atomic ratio or concertation.

The term “mill” or “milling” refers a process or technique known in the art as milling, which, for example, may be used to mill powders. Non-exhaustive examples of milling processes or techniques include ball milling, rotor milling, bead milling, cutting milling, and equivalent techniques. Preferably, but not necessarily, milling refers to ball milling.

The term “metal element” refers to a metal element of the Periodic Table of Elements, as would be understood by one of skill in the art. The term “transition metal element” refers to a metal element from the category of transition metal elements (preferably an element whose atom has a partially filled d sub-shell, or which can give rise to cations with an incomplete d sub-shell) of the Periodic Table of Elements, including lanthanide and actinide elements. The term “refractory metal element” refers to a metal element of the Periodic Table of Elements which have a melting point above 2000° C., high hardness at room temperature, preferably are chemically inert, preferably have a relatively high density, and preferably are stable against creep deformation to very high temperatures. Preferably, and unless otherwise stated, a refractory metal element is an element selected from the group consisting of Ti, V, Cr, Mn, Zr, Nb, Mo, Tc, Ru, Rh, Hf, Ta, W, Re, Os, and Ir.

The term “and/or” is used herein, in the description and in the claims, to refer to a single element alone or any combination of elements from the list in which the term and/or appears. In other words, a listing of two or more elements having the term “and/or” is intended to cover embodiments having any of the individual elements alone or having any combination of the listed elements. For example, the phrase “element A and/or element B” is intended to cover embodiments having element A alone, having element B alone, or having both elements A and B taken together. For example, the phrase “element A, element B, and/or element C” is intended to cover embodiments having element A alone, having element B alone, having element C alone, having elements A and B taken together, having elements A and C taken together, having elements B and C taken together, or having elements A, B, and C taken together.

The term “±” refers to an inclusive range of values, such that “X±Y,” wherein each of X and Y is independently a number, refers to an inclusive range of values selected from the range of X−Y to X+Y.

In an embodiment, a composition or compound of the invention, such as an alloy or precursor to an alloy, is isolated or substantially purified. In an embodiment, an isolated or purified compound is at least partially isolated or substantially purified as would be understood in the art. In an embodiment, a substantially purified composition, compound or formulation of the invention has a chemical purity of 95%, optionally for some applications 99%, optionally for some applications 99.9%, optionally for some applications 99.99%, and optionally for some applications 99.999% pure.

### DETAILED DESCRIPTION

In the following description, numerous specific details of the devices, device components and methods of the present invention are set forth in order to provide a thorough explanation of the precise nature of the invention. It will be apparent, however, to those of skill in the art that the invention can be practiced without these specific details. Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

The formation of titanium dioxide in Ti-6A1-4V powder during repetitive L-PBF processing causes the flexibility and toughness of the printed parts to decrease. Since the cost of the powder is high, reconditioning oxidized Ti-6Al-4V becomes appealing. The present reconditioning processes includes gas-phase etching, ball milling, and/or separating. The particles are firstly etched using a mixed chlorine and argon in a heated environment to expose titanium dioxide patches on particle surface. Then the titanium dioxide patches are removed with the ball-milling and the separation process, leaving clean Ti-6Al-4V powder free of oxidation.

In preferred embodiments, the titanium metal alloy materials reconditioned/deoxidized according to embodiments of methods disclosed herein are sufficiently deoxidized, having sufficiently low metal oxide or oxygen concentrations, to be useful for additive manufacturing (e.g., 3D metal printing) industry that uses titanium alloys, such as Ti64, to make parts for applications such as aerospace technology (e.g., engine components) and biomedical components (e.g., knee, shoulder, and hip replacement). These industries have some common requirements such as corrosion resistance, high strength, and large flexibility.

There are different approaches for removing oxides, such as gas phase etching and electrochemical etching. Electrochemical methods include, for example, FFC at 970° C. molten salt of CaCl₂) (trace CaO). The electrochemical approach is characterized by advantages such as friendly operation conditions (room temperature) and minimal side reactions but is characterized by disadvantages such as being a batch and very slow process, being complex for reducing mixed oxides (TiO₂, VO₂, and Al₂O₃), and having challenges in recycling expensive electrolyte and as well as challenges with scale up. An alternative approach for removing oxides is gas phase etching, optionally combined with solvent extraction. Advantages of the gas phase etching approach with solvent extraction include this approach being characterized as continuous and fast (20 s to 1 hour), using inexpensive solvents like isopropanol, being a relatively simple process (gas flow rate, temperature, and time), and being compatible with future PBF (fully continuous process). Disadvantages of the approach of gas phase etching with solvent extraction is being characterized by a corrosive environment and potentially requiring re-designed reaction vessel and monitoring byproducts.

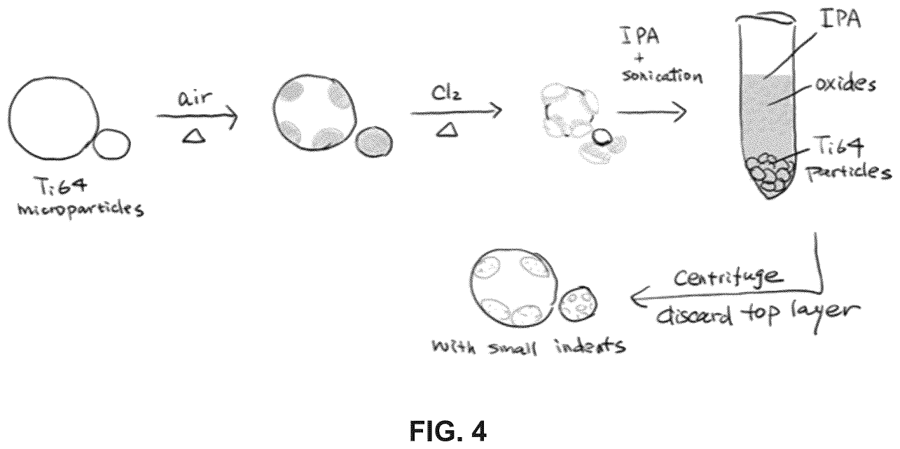

Surface oxides (TiO₂ and Al₂O₃) are generally inert. Converting TiO₂ to Ti requires high temperatures (e.g., >450° C.) and the use of catalyst (e.g., carbon nanotubes). As shown in the schematic of FIG. 4, gas phase etching and solvent extraction can instead be used to expose and remove thin layers of oxides.

Aspects disclosed herein include a method for deoxidization of a metal material comprising one or more metal oxide materials, the method comprising: reducing a concentration of the one or more metal oxide materials in the metal material from an initial concentration to a final concentration, thereby forming a deoxidized metal material; wherein the step of reducing comprises: etching the metal material using a reactive gas to expose one or more metal oxide materials; and separating the exposed one or more metal oxide materials from the etched metal material; wherein the step of separating comprises: processing the etched metal material in a solvent and extracting the exposed one or more metal oxide materials. Optionally, the metal material is a metal alloy material. Optionally, the metal alloy material is a titanium alloy material. Optionally, the titanium alloy material comprises a Ti-6Al-4V alloy. Optionally, the metal material is in the form of a powder.

Optionally in aspects disclosed herein, the gas and/or metal material is at a temperature greater than 50° C. Optionally in aspects disclosed herein, the gas and/or metal material is at a temperature greater than or equal to 200° C., optionally greater than or equal to 250° C. Optionally in aspects disclosed herein, the gas and/or metal material is at a temperature selected from the range of 200° C. to 500° C., optionally 250° C. to 450° C., optionally 250° C. to 400° C.

Optionally in aspects disclosed herein, the reactive gas comprises chlorine gas. Optionally in aspects disclosed herein, the step of etching comprises etching a metallic composition of the metal material. Optionally in aspects disclosed herein, the reactive gas etches titanium from the metal material resulting in exposing titania at surfaces of the metal material; wherein the metal material is a titanium alloy material. Optionally in aspects disclosed herein, the reactive gas reacts with and etches away Ti and/or V from the metal material; wherein the metal material is a titanium alloy material. Optionally in aspects disclosed herein, the step of etching comprises a reaction according to formula FX1:

$$Ti + 2 {Cl}_{2} \to {TiCl}_{4} . \qquad ( FX1 )$$

Optionally in aspects disclosed herein, the method further comprises milling the etched metal material after the step of etching and prior to the step of separating. Optionally in aspects disclosed herein, the milling step comprises ball milling.

Optionally in aspects disclosed herein, the one or more metal oxide materials comprise titania. Optionally in aspects disclosed herein, the final concentration of the one or more metal oxide material is sufficiently low for the deoxidized metal material to be useful for additive manufacturing. Optionally in aspects disclosed herein, the final concentration of the one or more metal oxide material in the deoxidized metal material is undetectable by EDAX. Optionally in aspects disclosed herein, the initial concentration of the one or more metal oxide material in the metal material is at least 2.5 at. % according to an EDAX technique. Optionally in aspects disclosed herein, the initial concentration of the one or more metal oxide material in the metal material is selected from the range of 3 at. % to 5 at. % according to an EDAX technique.

Optionally in aspects disclosed herein, the solvent comprises an organic solvent. Optionally in aspects disclosed herein, the step of processing comprises sonicating the etched titanium alloy material in the solvent. Optionally in aspects disclosed herein, the step of separating comprises centrifuging and extracting the solvent having the exposed one or more metal oxide materials dispersed in the solvent.

Aspects disclosed herein include a method as described herein for processing or reconditioning a metal material having one or more metal oxides. Aspects disclosed herein include a metal material having been processed or reconditioned according to any embodiments described herein. Aspects disclosed herein include a titanium alloy material having been processed or reconditioned according to any embodiments described herein.

The invention can be further understood by the following non-limiting examples.

### Example 1: Intentionally Oxidizing Titanium Alloy Material to Mimic Thermal Oxidation in Additive Manufacturing

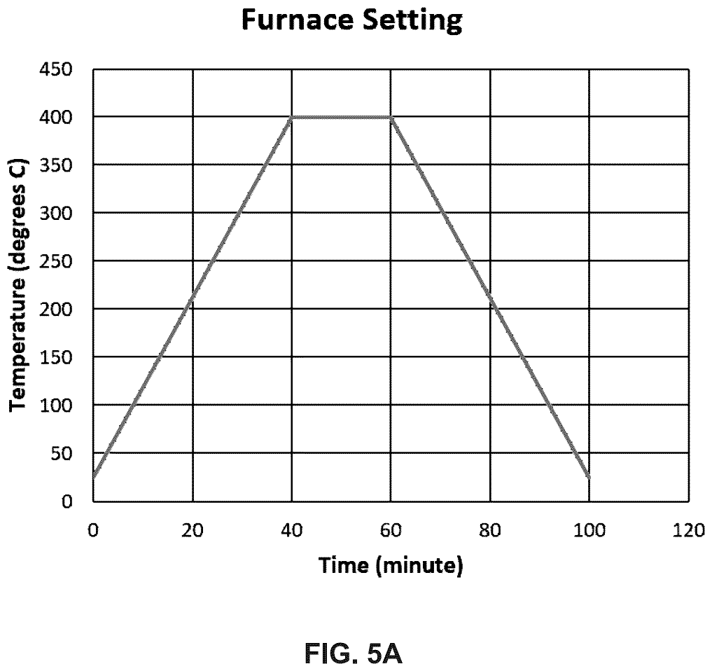

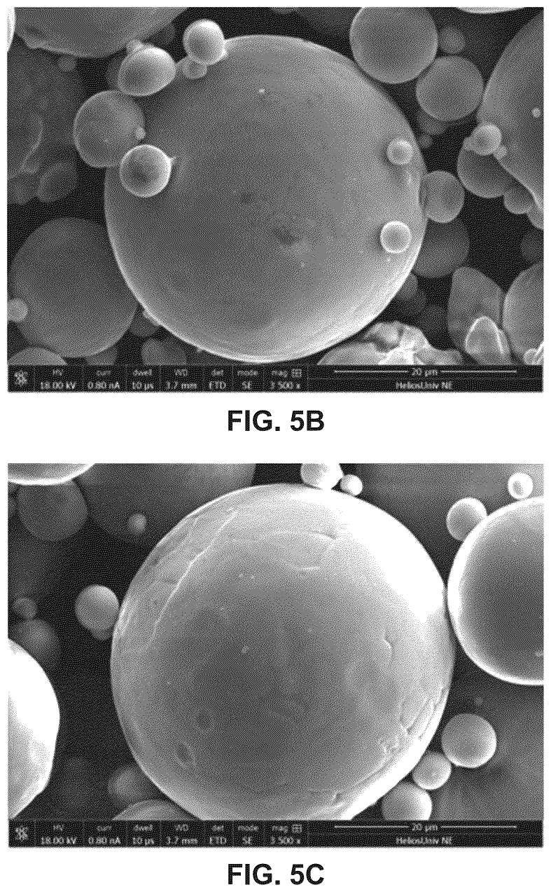

FIG. 5A shows a temperature-vs-time for an exemplary furnace process for growing an oxide layer on a titanium alloy material. SEM images show no noticeable change but particle visible color changed from gray to slightly brown.

For example, fresh, unoxidized, Ti64 powders from Tekna are baked briefly under elevated temperatures (e.g., 300, 350, or 400° C.), in air.

For example, the oxygen weight percent of selected oxidized particles is 3.65% and

3.53%, with averaging of 3.59%.

### Example 2: Etching

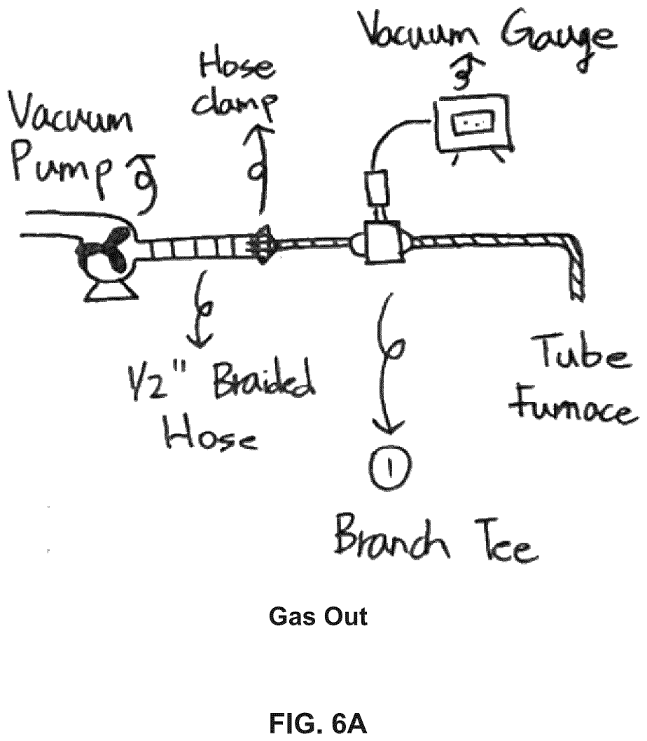

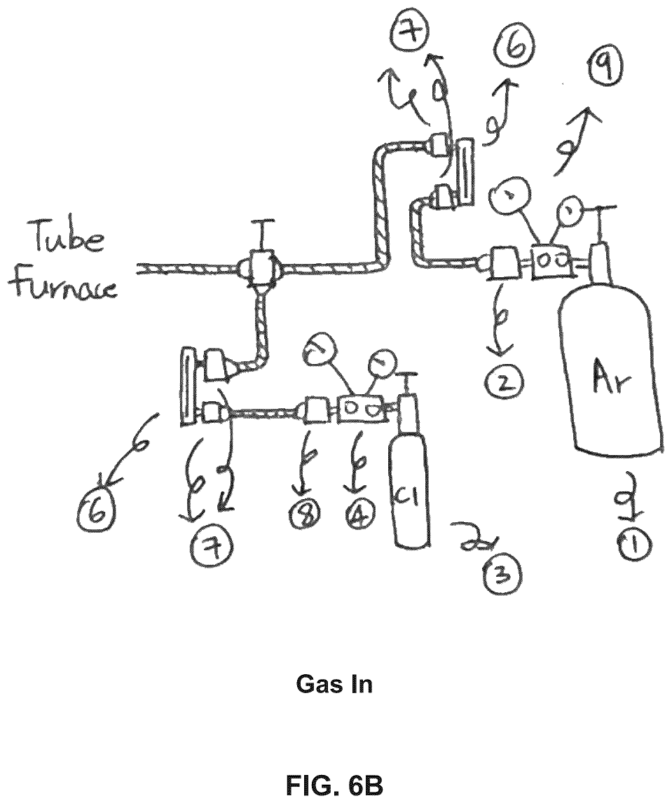

FIGS. 6-12 relate to exemplary embodiments of gas phase etching.

For example, a reactive gas, such as, but not necessarily, Cl₂ (other gases can be used) is provided in contact with an oxidized titanium alloy material, such as by being feed into a powder bed (furnace tube with oxidized Ti64 powders placed inside, in embodiments) and allowed to react with metals. Typically, but not necessarily, the reactive has is a gas mixture including a reactive gas with an inert carrier gas such as argon at a specified flow rate and temperature (e.g., <350° C.). Reaction(s) between the titanium alloy material and the reactive gas occur on surfaces and inside the oxide diffusion zone.

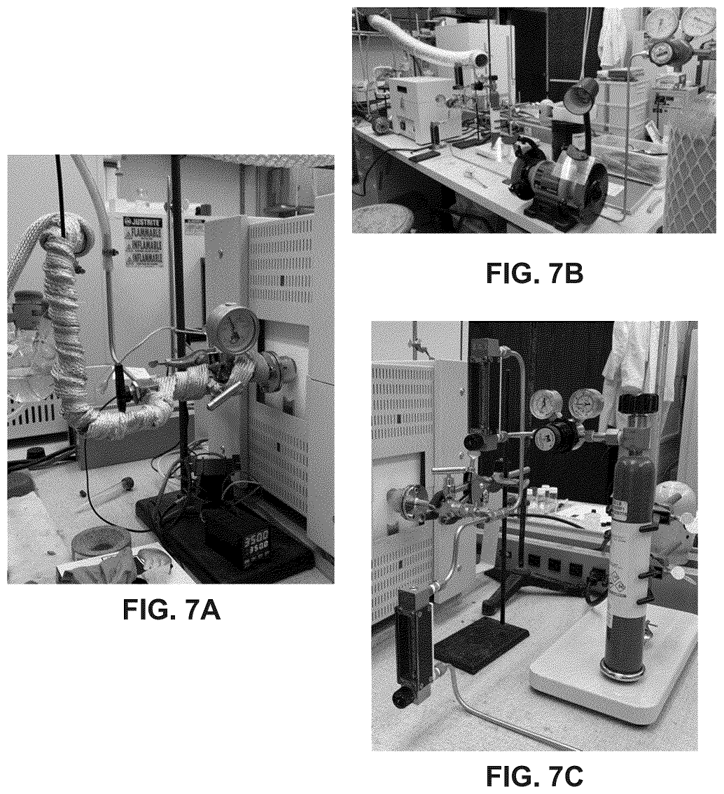

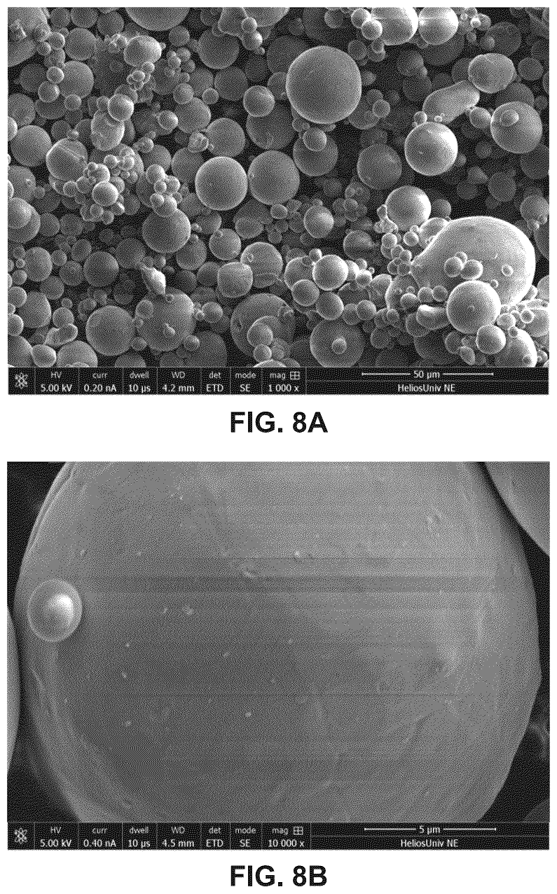

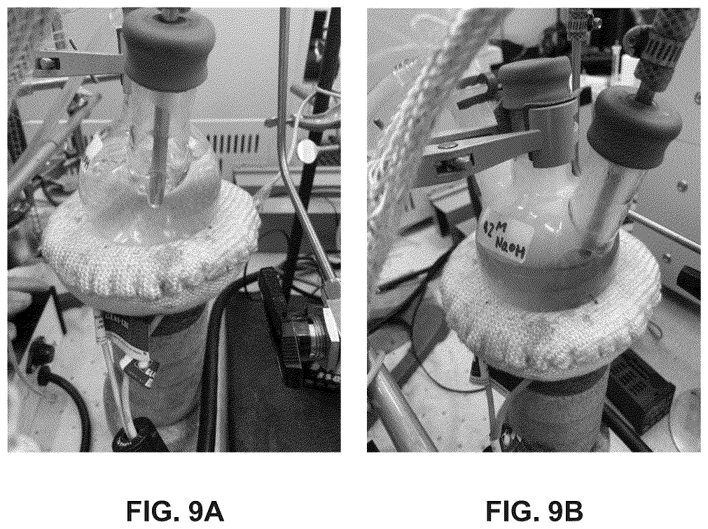

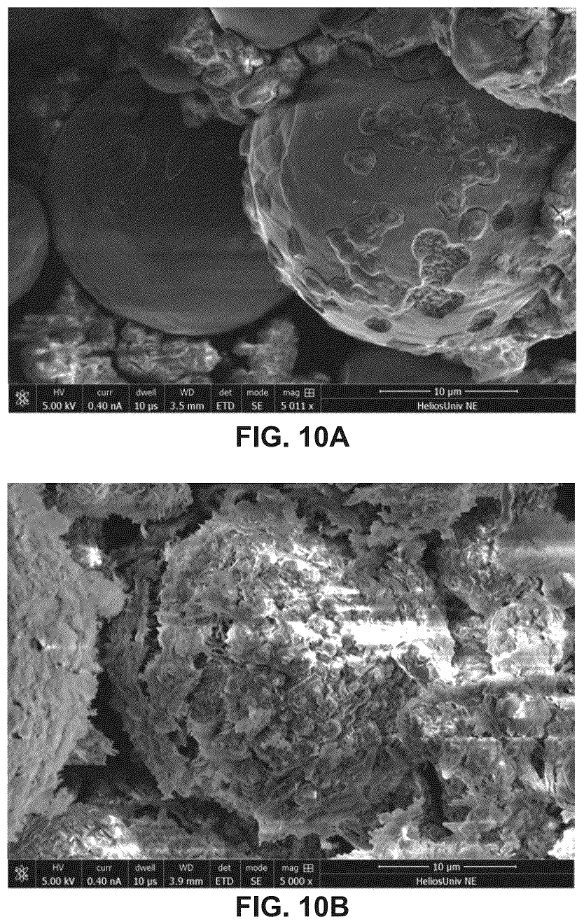

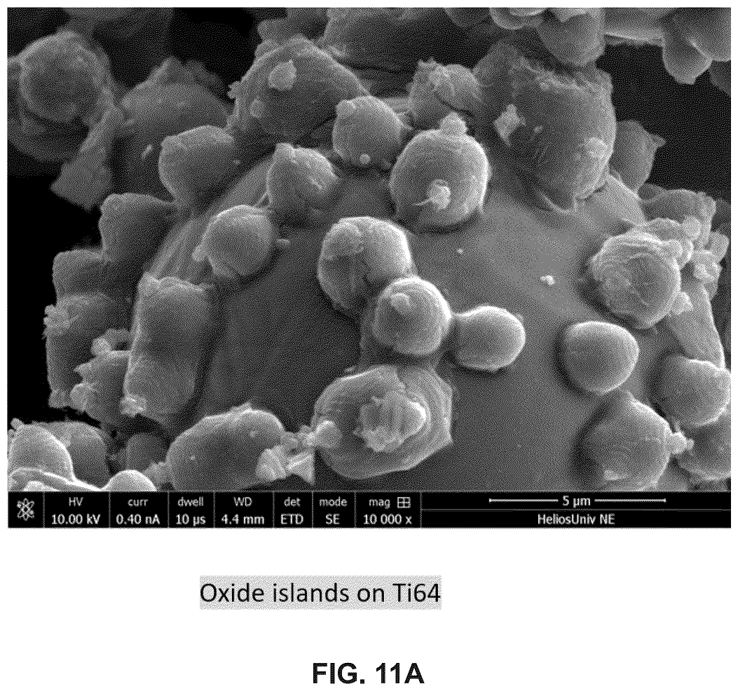

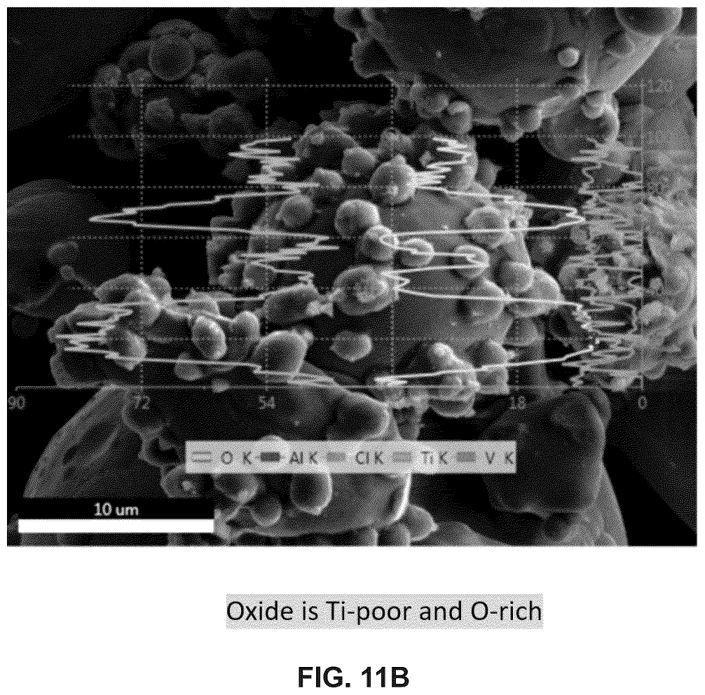

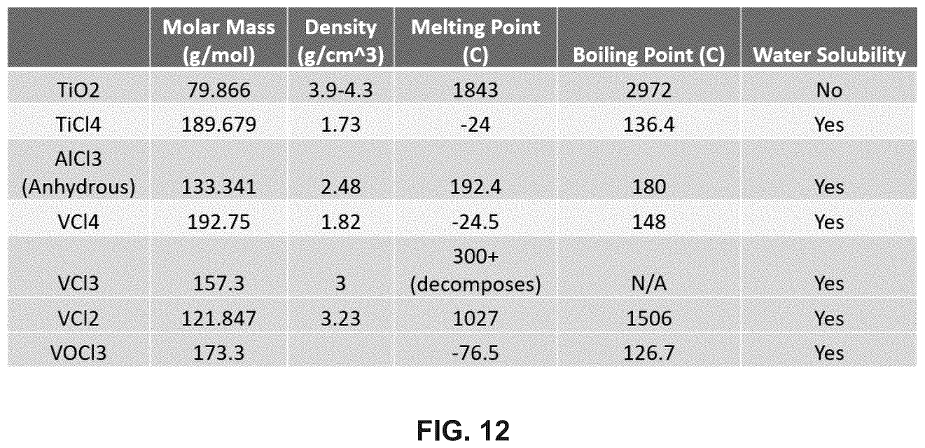

FIGS. 6A-6B show schematics and FIGS. 7A-7C show photographs of portions of working examples related to exemplary systems, according to certain embodiments, for performing the gas phase etching with a reactive gas upon an alloy powder. FIGS. 8A-8B show SEM images of oxidized titanium alloy powders, showing that though charging evident in the SEM images is evidence of presence of electrically insulating materials such as metal oxide materials, the specific locations of the metal oxide materials cannot be determined from the images. FIGS. 9A-9B are photographs of a working example of reactive etching of the oxidized titanium alloy powders with reactive gas comprising Cl₂ gas. The smoke corresponds to formation of TiCl₄ from reaction of the Cl₂ and Ti in the titanium alloy powder, resulting in the etching of titanium (Ti) which in turn exposes portions of metal oxide materials (e.g., TiO₂), as seen in FIGS. 10A-11B. In embodiments, metal oxide materials are exposed because oxide materials such as TiO₂ are generally inert or much slower to react with a reactive gas such as Cl₂ compared to the metallic elements (Ti, V, etc.) of the alloy. For example, FIGS. 10A-10B show SEMs of powder (Ti64) oxidized at 400° C. for 20 minutes and then subsequently etched in a sealed tube using Cl₂ as a reactive gas. FIGS. 11A-11B show SEMs of powder (Ti64) oxidized at 350° C. for 1 hour and then subsequently etched in a sealed tube using Cl₂ as a reactive gas. In embodiments, exposed metal oxide patches/islands/portions may be generally rough and porous. In embodiments, the exposed metal oxide portions may be Ti-poor and O-rich as shown in FIG. 11B. FIG. 12 shows a table of material properties for TiO₂ and chloride materials that may be formed as a result of reactions between reactive Cl₂ gas and elements of the titanium alloy powder.

### Example 3: Separation Via Solvent Extraction

In embodiments, for example, at least a fraction of the metal oxide materials are separated from the non-oxidized titanium alloy material using solvent extraction, optionally with an organic solvent (e.g., isopropanol), or solvent mixture. The oxide diffusion zone may be not a dense layer of oxide but instead comprise mixtures of metal alloy and metal oxide materials (Al₂O₃, TiO₂, and others). As such, in embodiments, the etching process will produce a highly porous and therefore low density “shell” on powder surfaces. The patches or shell of metal oxide may then be removed by solvent extraction, for example, optionally aided by sonication of the solvent and powder mixture.

Subsequently, separation or extraction may be facilitated by applying centrifugation to the powder-in-solvent mixture. The low density and polar oxide layer or portions can form a colloidal suspension in the organic solvent. Metal powders, on the other hand, generally remain precipitates in the solvent. A centrifuge process, therefore, will condense the mixture into two solid layers of metal oxide materials and non-oxidized metal/alloy powders, with clean solvent on the top. After the solvent and oxide layer are removed, the bottom layer, which comprises the oxide-free (or oxide-reduced) alloy material, is collected and dried.

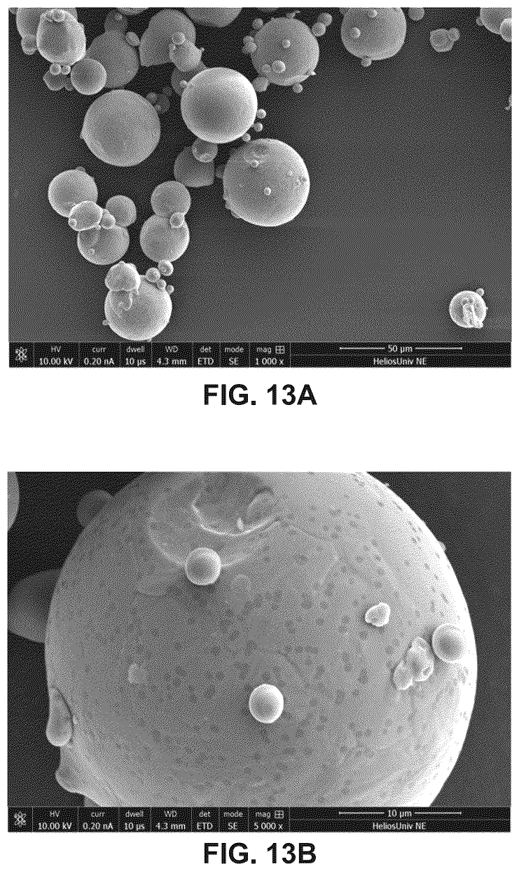

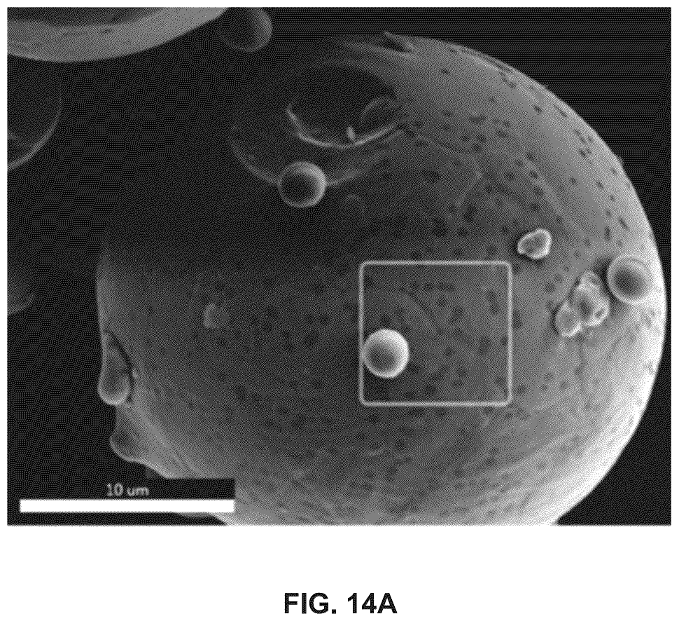

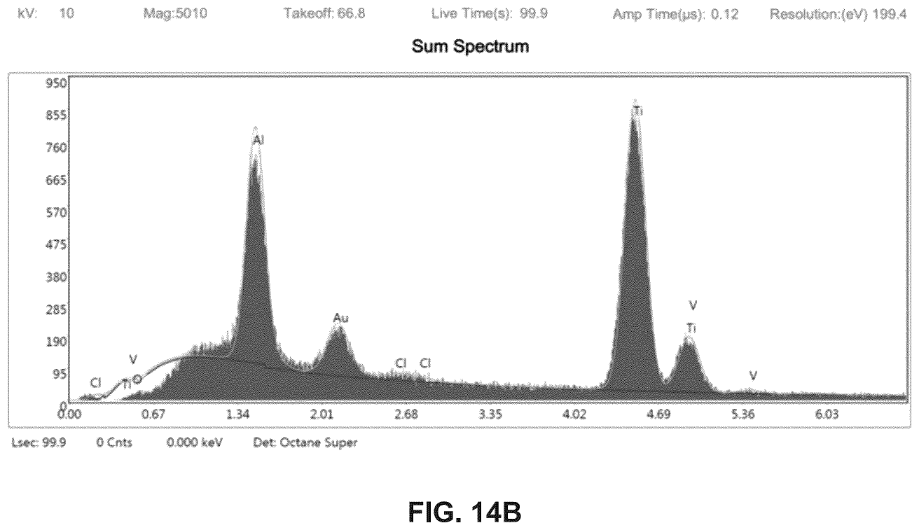

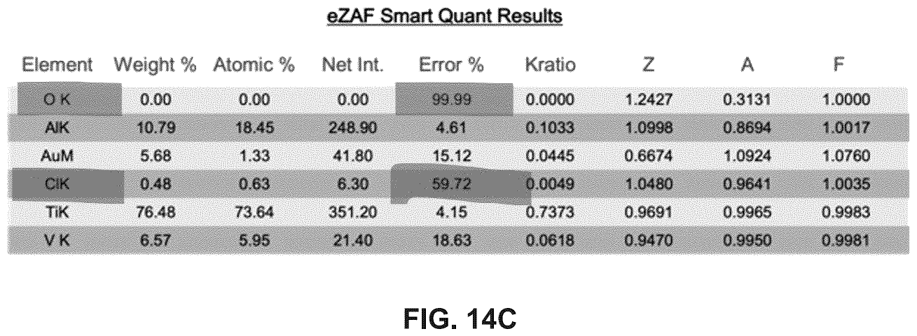

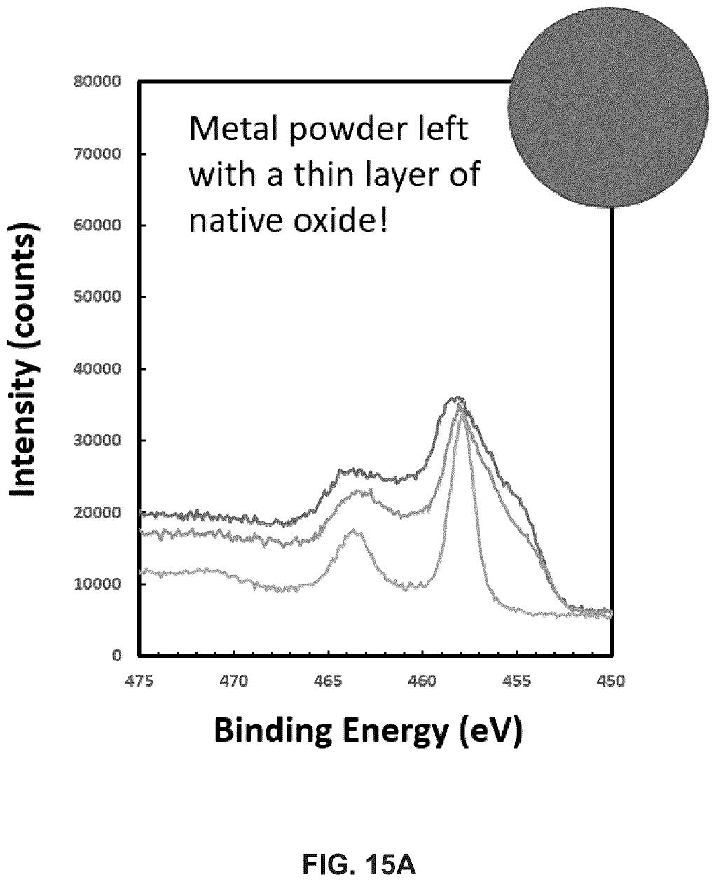

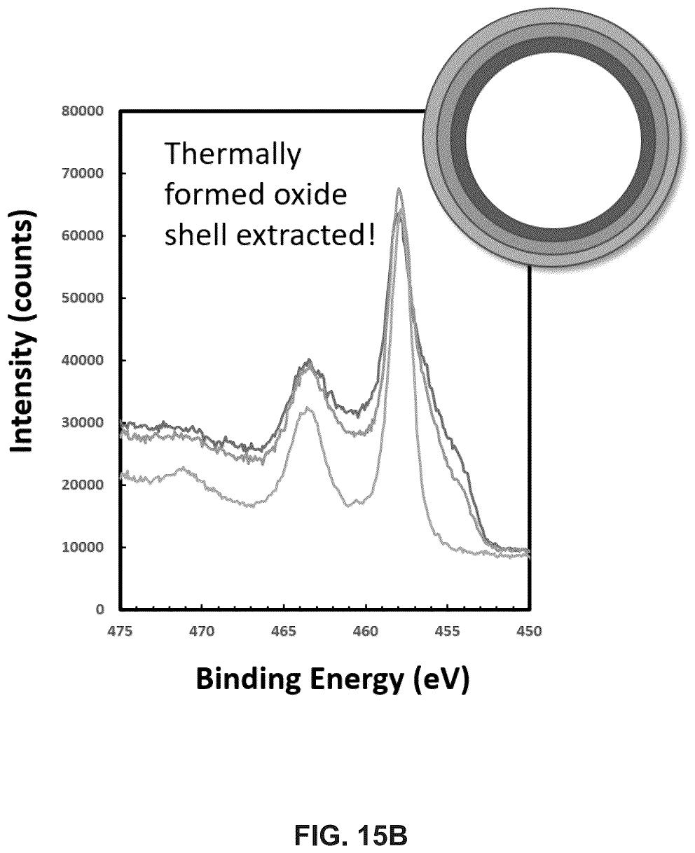

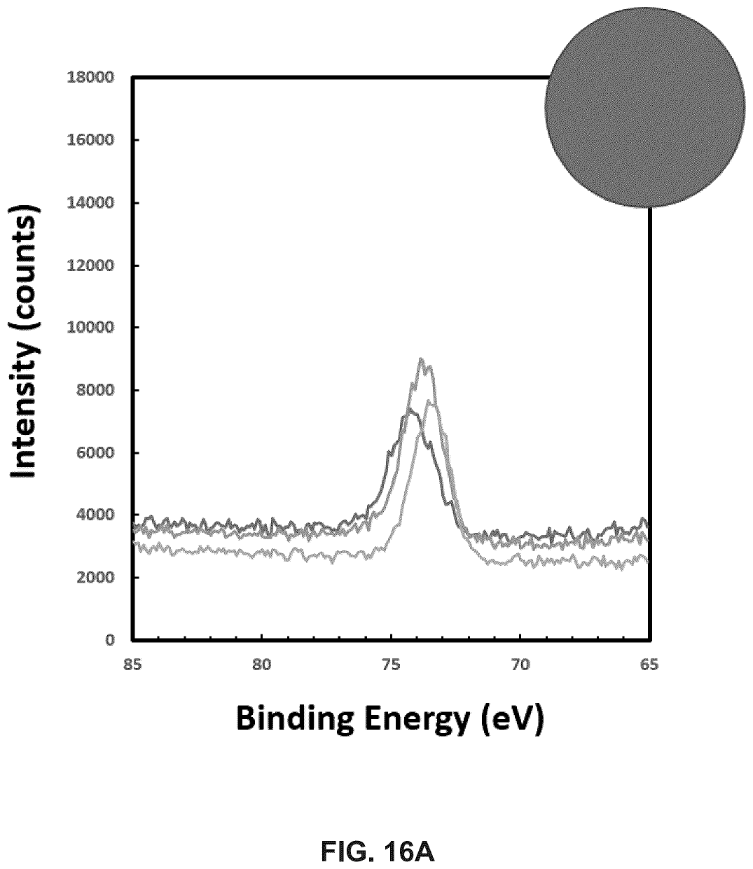

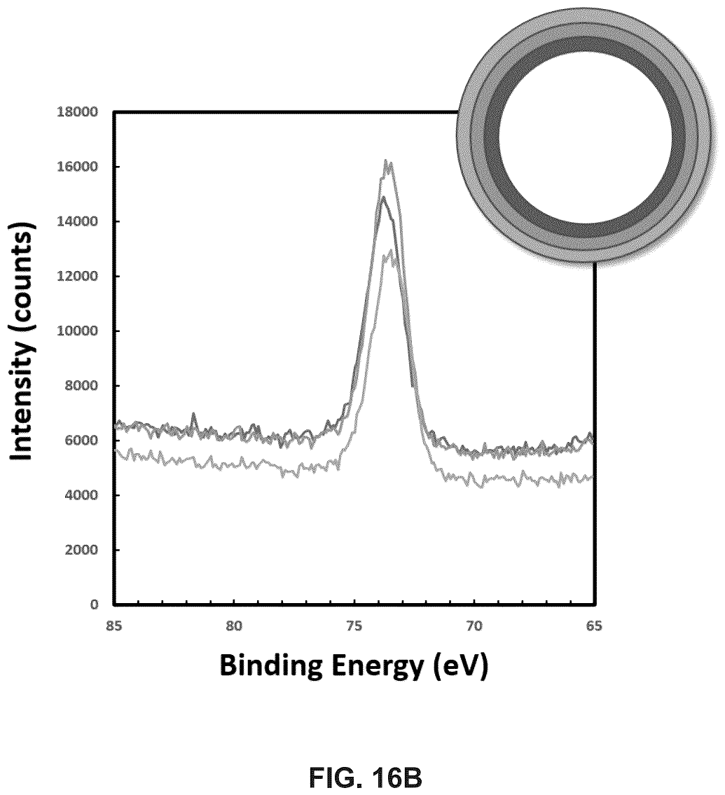

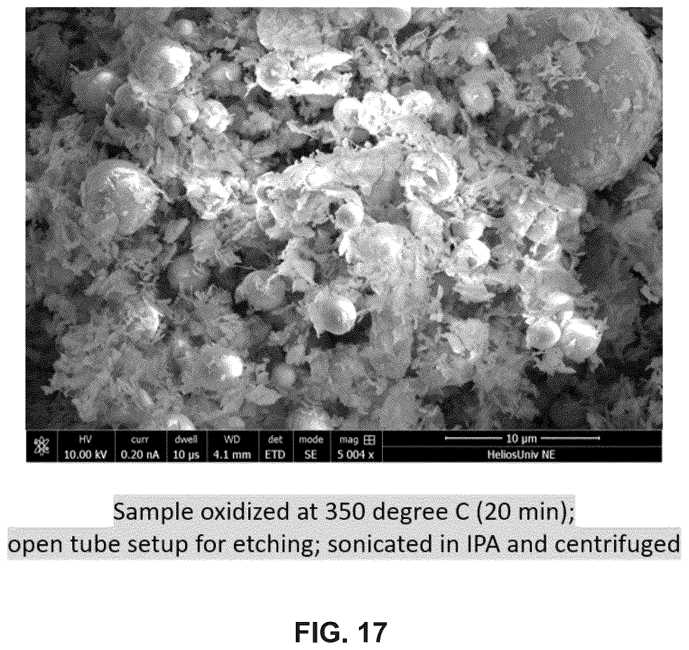

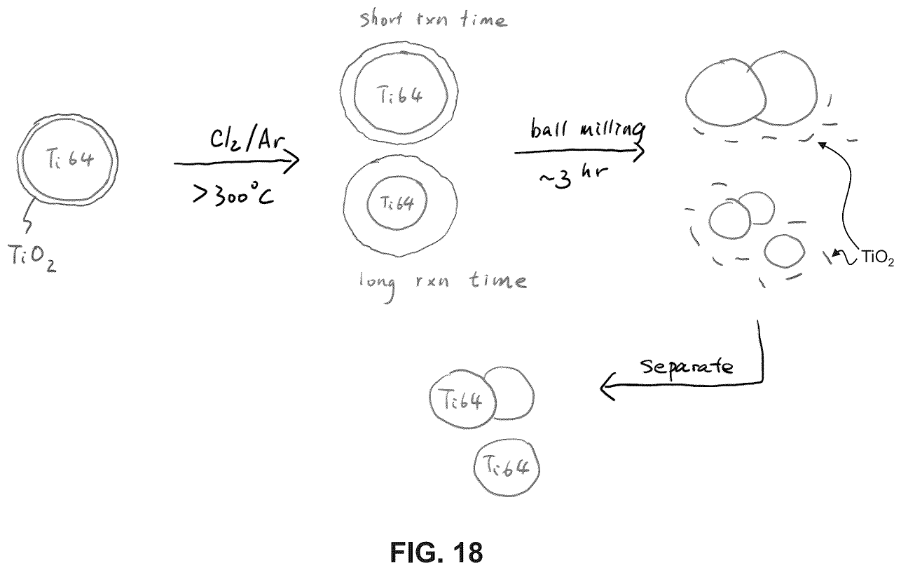

FIGS. 13A-13B show SEM images of extracted metal alloy powder, which corresponds to the reconditioned or deoxidized titanium alloy material. The sample shown in these figures was first oxidized at 350° C. for 20 minutes, then etched in an open tube setup using Cl₂ gas, then sonicated in IPA and centrifuged. FIG. 17 shows the extracted metal oxide materials (also referred to as removed/extracted surface oxide) from material processed under same conditions as that of FIG. 13.

### Statements Regarding Incorporation by Reference and Variations

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Every device, system, formulation, combination of components, composition, step, or method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A method for deoxidization of a metal material comprising one or more metal oxide materials, the method comprising:
reducing a concentration of the one or more metal oxide materials in the metal material from an initial concentration to a final concentration, thereby forming a deoxidized metal material; wherein the step of reducing comprises:
etching the metal material using a reactive gas to expose one or more metal oxide materials; and
separating the exposed one or more metal oxide materials from the etched metal material.

2. The method of claim 1, wherein the step of separating comprises processing the etched metal material in a solvent and extracting the exposed one or more metal oxide materials.

3. The method of claim 1, wherein the metal material is a metal alloy material or a titanium alloy material.

4. (canceled)

5. (canceled)

6. The method of claim 1, wherein the metal material is in the form of a powder.

7. The method of claim 1, wherein the gas and/or metal material is at a temperature greater than 50° C. or greater than 200° C.

8. (canceled)

9. The method of claim 1, wherein the reactive gas comprises chlorine gas.

10. The method of claim 1, wherein the step of etching comprises etching a metallic composition of the metal material.

11. (canceled)

12. (canceled)

13. The method of claim 1, wherein the step of etching comprises a reaction according to formula FX1:
$$Ti + 2 {Cl}_{2} \to {TiCl}_{4} . \qquad ( FX1 )$$

14. The method of claim 1, further comprising milling the etched metal material after the step of etching and prior to the step of separating.

15. (canceled)

16. The method of claim 1, wherein the one or more metal oxide materials comprise titania.

17. The method of claim 1, wherein the final concentration of the one or more metal oxide material is sufficiently low for the deoxidized metal material to be useful for additive manufacturing.

18. The method of claim 1, wherein the final concentration of the one or more metal oxide material in the deoxidized metal material is undetectable by an EDAX technique, and wherein the initial concentration of the one or more metal oxide material in the metal material is at least 2.5 at. % according to the EDAX technique.

19. (canceled)

20. (canceled)

21. (canceled)

22. The method of claim 2, wherein the step of processing comprises sonicating the etched titanium alloy material in the solvent.

23. The method of claim 2, wherein the step of separating comprises centrifuging and extracting the solvent having the exposed one or more metal oxide materials dispersed in the solvent.

24. A metal material having been processed or reconditioned according to the method of claim 1.

25. A titanium alloy material having been processed or reconditioned according to the method of claim 1.

26. The method of claim 1, wherein the metal material includes titanium alloys of different history, different shelving life, and/or different amounts of oxygen concentration.

27. The method of claim 1, wherein the metal material includes a titanium alloy and wherein the reaction temperature varies with the oxygen content, with up to a 5° C. increase per 10 ppm increase in the oxygen concentration.

28. The method of claim 1 wherein the metal material includes a mixture of one or more titanium alloy powders with differing amounts of oxygen content.

29. The method of claim 28, wherein a number of different powders in the mixture is equivalent to a number of different reaction temperatures.

30. (canceled)
